(19) United States
(12) Patent Application Publication
(10) Pub. No.: US 2022/0391969 A1
(43) Pub. Date: Dec. 8, 2022

(54) SYSTEMS, METHODS, AND USER INTERFACES FOR OBTAINING INDEPENDENT-PROVIDER SERVICES

(71) Applicant: Barel IP, Inc., Salt Lake City, UT (US)

(72) Inventors: Brian Bennett, Parrish, FL (US); Ava Slifko, Sarasota, UT (US)

(21) Appl. No.: 17/585,907

(22) Filed: Jan. 27, 2022

Related U.S. Application Data
(60) Provisional application No. 63/197,723, filed on Jun. 7, 2021.

(51) Int. Cl. G06Q 30/06; G06Q 30/02

(52) U.S. Cl. CPC G06Q 30/0641; G06Q 30/0282

(57) ABSTRACT

Technologies are described for displaying independent-provider profiles in a user-interface to provide independent-providers a more equal opportunity of being selected for a service request. An example of the technology includes receiving a service request and identifying independent-provider profiles to display in a user-interface as candidates to perform the service request, wherein the independent-provider profiles are selected using factors to provide each independent-provider profile, included in a provider pool that corresponds to the parameters of the service request, a possibility of being selected. The independent-provider profiles can be dynamically displayed in one of a plurality of locations in a provider display region of the user-interface, wherein at least a part of a set of independent-provider profiles dynamically displayed in one of the locations of the provider display region can be replaced with different independent-provider profiles from the provider pool in response to an expiration time or a refresh action.

### RELATED APPLICATION

This application claims priority to U.S. Provisional Application No. 63/197,723, filed Jun. 7, 2021 which is incorporated herein by reference.

### BACKGROUND

The development of information and communication technologies, such as the Internet and the popularization of Internet connected devices, has given rise to the digitalization of the economy and industry. As a result, on-demand platforms based on digital technology have created jobs and alternative types of employment that are differentiated from existing offline transactions by the level of accessibility, convenience, and price competitiveness made possible by the Internet. These on-demand platforms cover a large field of domains, including: rental, travel, food delivery, transportation, home services, pet services, education, and others. These types of on-demand platforms have created a new labor force which is characterized by independent service providers who can interact with the on-demand platforms to obtain work, which allows the independent service providers more flexibility to choose projects that best align with their goals and interests, and the ability to earn income from multiple sources.

### SUMMARY

Systems, methods, and user interfaces for obtaining independent-provider services is disclosed. In one example, a system or method for a user-interface to display independent-provider profiles can receive parameters that define a service request. In response to receiving the service request, the system can identify a set of independent-provider profiles to display in the user-interface as candidates to perform the service request. A provider-dynamics model can select the set of independent-provider profiles using factors to provide each independent-provider profile included in a provider pool that corresponds to the parameters of the service request a possibility to be included in the set of independent-provider profiles. Also, the provider-dynamics model can manage a flow of independent-provider profiles moving in-and-out of the provider pool by removing independent-provider profiles from the provider pool in response to receiving service requests, and returning the independent-provider profiles to the provider pool when the independent-provider profiles are not selected for the service requests.

Having identified the set of independent-provider profiles, the profiles can be dynamically displayed in one of a plurality of locations in a provider display region of the user-interface. Each location in the provider display region can correspond to one or more factors used by the provider-dynamics model to select sets of independent-provider profiles from the provider pool. At least a part of the set of independent-provider profiles dynamically displayed in one of the locations of the provider display region can be replaced with different independent-provider profiles selected by the provider-dynamics model from the provider pool in response to an expiration time or a refresh action. A user can select an independent-provider profile displayed in the user-interface to perform the service request, and a message can be sent to a client device of the independent-provider to provide notice that the independent-provider has been selected to perform the service request.

There has thus been outlined, rather broadly, the more important features of one or more embodiments so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a diagram illustrating a high-level example of a service-provider system configured to provide customers access to independent-providers who are available to perform on-demand services.

FIG. 2 is a block diagram that illustrates an example system for managing a flow of independent-provider profiles moving in-and-out of a provider pool in response to service requests.

FIGS. 3A-C illustrate examples of a customer user-interface that dynamically displays profiles for independent-providers who are available to perform a service request.

FIG. 4 illustrates an example of an expanded profile for an independent-provider.

FIGS. 5A-E are flow diagrams illustrating an example method for dynamically displaying independent-provider profiles in a user-interface.

FIG. 6 is a flow diagram that illustrates an example method for a user-interface to display independent-provider profiles.

FIG. 7 is a flow diagram that illustrates an example method for holding an independent-provider during a customer review period.

FIG. 8 is a flow diagram that illustrates an example method for requesting a service using a customer user-interface.

FIG. 9 is a block diagram illustrating an example of a computing device that may be used to execute the present technologies described herein.

These drawings are provided to illustrate various aspects of the technology and are not intended to be limiting.

### DETAILED DESCRIPTION

Before the present technology is disclosed and described, it is to be understood that this disclosure is not limited to the particular structures, process steps, or materials disclosed herein, but is extended to equivalents thereof as would be recognized by those ordinarily skilled in the relevant arts. While examples of the technology are described in sufficient detail to enable those skilled in the art to practice the invention, it should be understood that other embodiments may be realized and that various changes to the technology may be made without departing from the spirit and scope of the present technology. Thus, the following more detailed description of the technology is not intended to limit the scope of the technology, as claimed, but is presented for purposes of illustration only and not limitation to describe the features and characteristics of the present technology, to set forth the best mode of operation of the technology, and to sufficiently enable one skilled in the art to practice the technology. Accordingly, the scope of the present technology is to be defined solely by the appended claims.

Technologies are described for a service-provider system comprising software applications, application programming interfaces (APIs), and user-interfaces to provide customers access to independent-providers who are available to perform on-demand services. In particular, a customer user-interface that dynamically displays independent-provider profiles allows customers to review the independent-provider profiles and book on-demand services from an independent-provider (e.g., “gig” worker) listed in the independent-provider profiles. A customer can submit a service request via the customer user-interface to a server that hosts a provider-dynamics model that selects a set of independent-provider profiles to display in the customer user-interface. The provider-dynamics model can select the independent-provider profiles using factors to provide each independent-provider profile, included in a provider pool that corresponds to the parameters of the service request, a possibility to be included in the set of independent-provider profiles. As part of selecting the set of available independent-providers, the provider-dynamics model can place a temporary hold on the independent-providers that prevents the independent-providers from fulfilling other service requests, allowing the customer time to review the profiles of the independent-providers and make a selection of an independent-provider to perform the service request.

Display of the independent-provider profiles may be dynamic, in that, at least a part of the set of independent-provider profiles can be replaced with different independent-provider profiles selected from the provider pool in response to an expiration time and/or a refresh action (e.g., a user requested refresh or a timed refresh). A user can select an independent-provider profile displayed in the customer user-interface to perform the service request, and a message can be sent to a client device of the independent-provider to provide notice that the independent-provider has been selected to perform the service request

In the case of subscriptions or dates of services beyond a current date and time, the same process above can apply. However, in the case of future dates or repeating dates, a customer can apply their choice of an independent-provider ahead of time (e.g., up to 5 separate service dates). This can be accomplished via a pool of independent-providers who have identified themselves as available to be placed in search for future dates, multiple dates concurrently, and with no defined time period. The option of choosing the independent-provider using the service-provider system allows customers to make a knowledgeable decision, dramatically reducing the expense of cancellations and secondary requests due to autonomously made non-compatible matches.

The current technologies may benefit an independent-provider in a way that was not previously available. Previous systems connected customers and independent-providers using two distinct metrics, a cumulative scoring system combining customer feedback and on-time performance, plus geolocation. The current technologies can use these two distinct metrics to identify preferred independent-provider profiles, which may be initially provided as choices to a customer, but should the customer decide to review more than the initial independent-provider profiles, additional profiles can be returned in a non-bias and random order using the provider-dynamics model described herein. This non-biased return facilitates equal visibility of independent-providers outside of performance metrics for each independent-provider available at the service request time. That is, an independent-provider is not assigned to a customer to perform a service request; instead, the customer is provided with the ability to make an informed decision about which independent-provider is selected by dynamically displaying independent-provider profiles in a customer user-interface. This allows for customer individual choice and a more robust opportunity for independent-providers to increase visibility in a non-biased offering.

The current technologies are an improvement to prior “gig” work or real-time and on-demand service platforms, in that none of the prior service platforms allow for the choice of an independent-provider to provide a requested service. Moreover, none are able, without bias, to return both preferred and all other available independent-providers for review. No prior technology provides for on-demand selection of independent-providers via a non-bias selection of available independent-providers to provide each independent-provider in a provider pool a possibility of being selected.

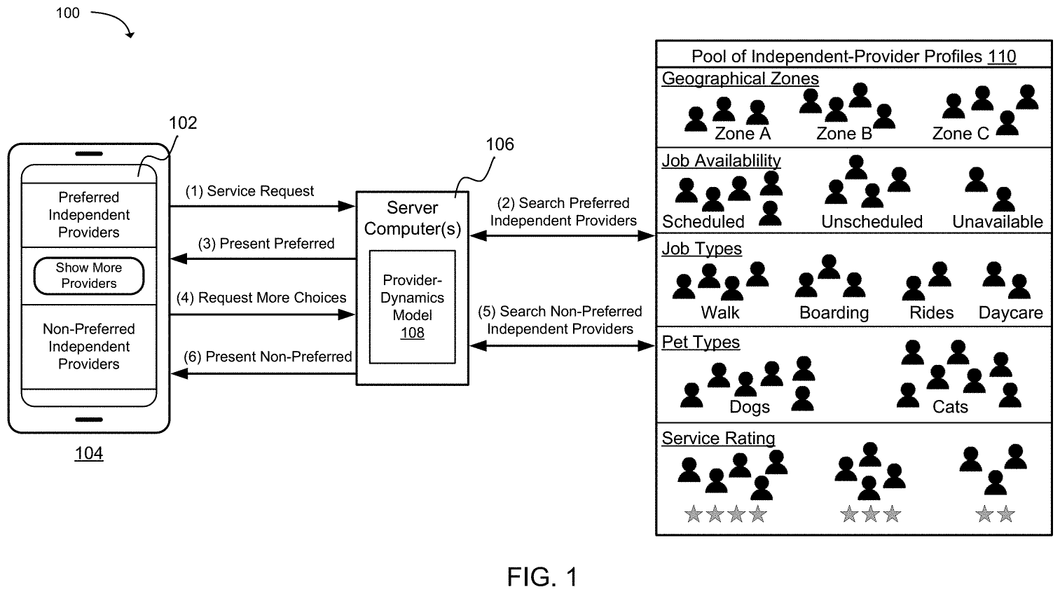

To further describe the present technology, examples are now provided with reference to the figures. FIG. 1 is a diagram illustrating a high-level example of a service-provider system 100 configured to provide customers access to independent-providers who are available to perform on-demand services. Independent-providers may be “gig” workers such as, independent contractors, online platform workers, contract firm workers, on-call workers, and temporary workers. As shown, a client device 104 associated with a customer can host a customer user-interface 102. The customer can make service requests using the customer user-interface 102. The service requests can include a plurality of parameters or variables that define the service request (e.g., date/time, location, type of service, independent-provider preferences, service rating, etc.).

The customer user-interface 102 may send the service request via an application programming interface (API) to a server 106 in the service-provider system 100 that manages a pool of independent-provider profiles 110. Illustratively, the information in the independent-provider profiles can include job availability status, availability schedule, location, zone, job types, pet types, service rating (e.g., customer rating, internal rating comprising: acceptance rating, on-time rating, amount of time-on-platform, number of completed services, etc., and other types of ratings) In response to receiving the service request, the server 106 can identify independent-providers who have indicated their availability to perform service requests.

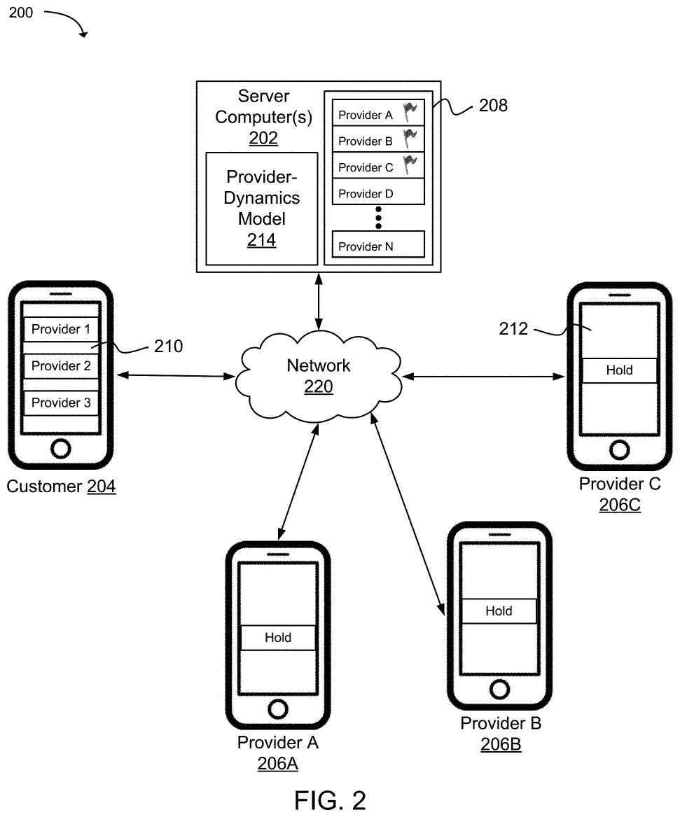

The server 106 can host a provider-dynamics model 108 that manages a flow of independent-provider profiles moving in-and-out of the provider pool 110 by removing independent-provider profiles from the provider pool 110 in response to receiving service requests, and returning the independent-provider profiles to the provider pool 110 when the independent-provider profiles are not selected for the service requests. In response to receiving a service request, the provider-dynamics model 108 may query the pool of independent-provider profiles 110 to identify a set of independent-providers (e.g., 2, 3, or more) whose information corresponds to the service request parameters. As described in greater detail in association with FIG. 2, a hold can be placed on the set of independent-providers to prevent the independent-providers from being selected for other service requests during a time in which the customer can review the independent-providers.

In one example, an initial set of independent-providers selected by the provider-dynamics model 108 can comprise preferred independent-providers whose profile information, for example, indicates that the independent-providers are scheduled to accept service requests at the service request time, and whose profile information corresponds to the parameters of the service request (e.g., geographic zone, job type, pet type, service rating, etc.). Rating metrics can be used to identify preferred independent-providers, such as providers who have the highest cumulative metrics as determined by individual ratings from previous services. Additionally, the preferred independent-providers may have placed themselves in availability before the service request was made, and may be within the defined geographical boundaries of the service request, or a software dedicated zone of the request. Preferred and non-preferred status of independent-providers may depend on their rating within a dedicated population of independent-providers at the time that a service request is made. An independent-provider may fall out of preferred status due to their rating at any given time.

After identifying the initial or first set of independent-providers, the server 106 can send the independent-provider profiles to the client device 104 to be displayed on the customer user-interface 102. The customer can review the profiles of the independent-providers and select an independent-provider to perform the service request. Alternatively, the customer can request a second set of independent-providers for review. For example, the service-provider system 100 may allow a customer desiring more options beyond the initial set of independent-provider to view additional independent-providers using a “more” function (e.g., via a “show more” control in the customer user-interface 102). In response, the provider-dynamics model 108 may select a second set of independent-provider profiles from the provider pool 110 and return the second set of independent-provider profiles to the client device 104 for display on the customer user-interface 102. In one example, as part of identifying a second set of independent-provider profiles, the provider-dynamics model 108 can identify on-demand or unscheduled independent-providers who have not previously confirmed their availability but have chosen to make themselves available to perform service requests by submitting their available status (e.g., by “going live”) to the service-provider system 100. A customer can request additional independent-provider profiles (e.g., via the “show more” function) until the independent-provider profiles in the provider pool 110 matching the service request parameters have been exhausted.

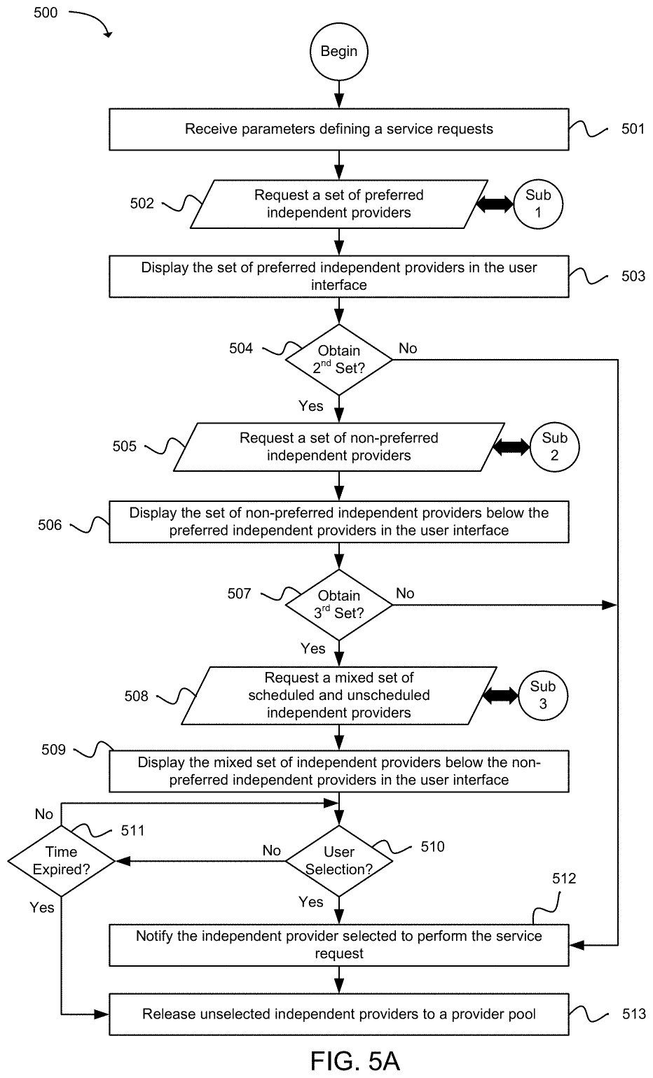

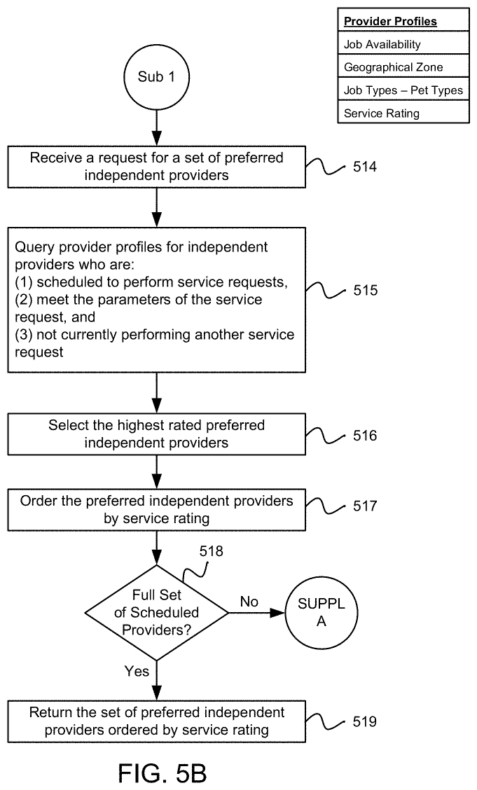

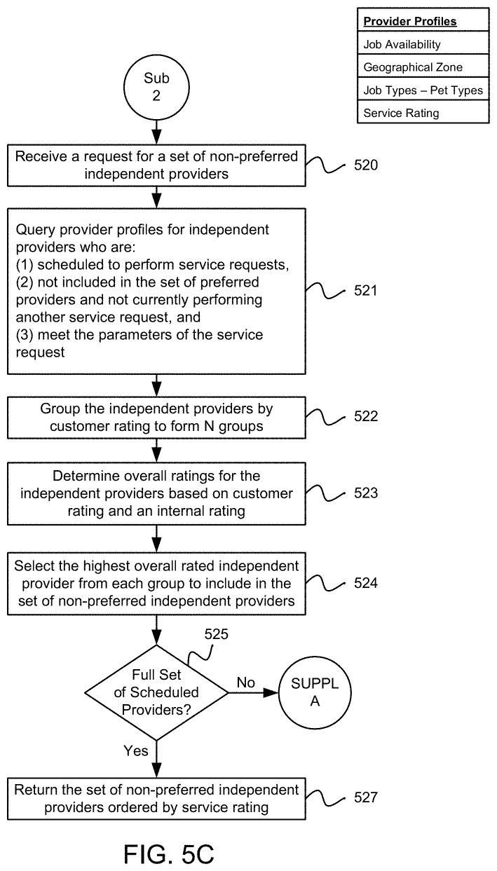

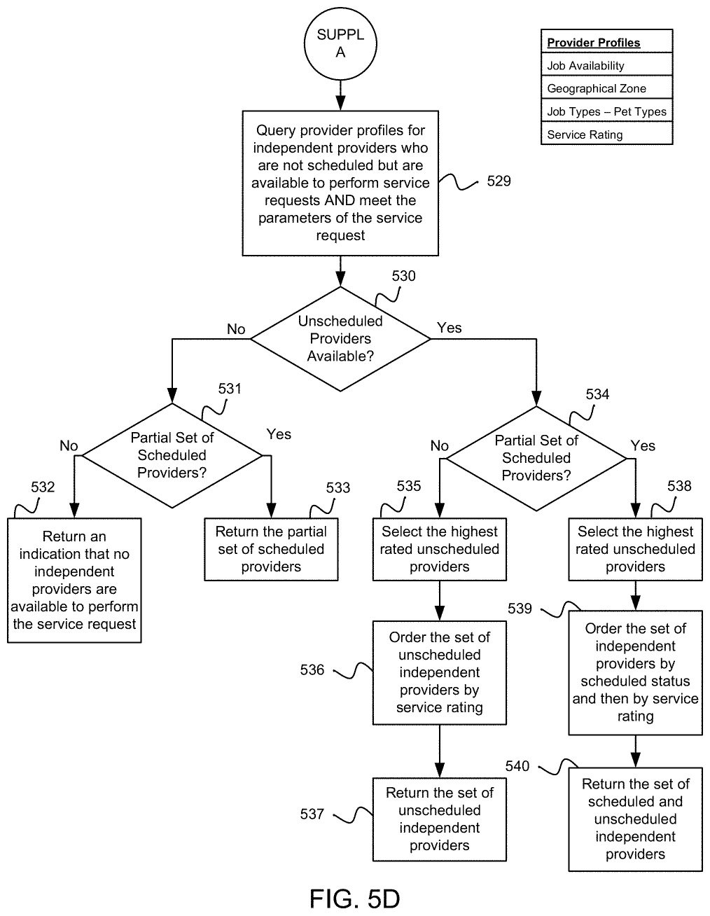

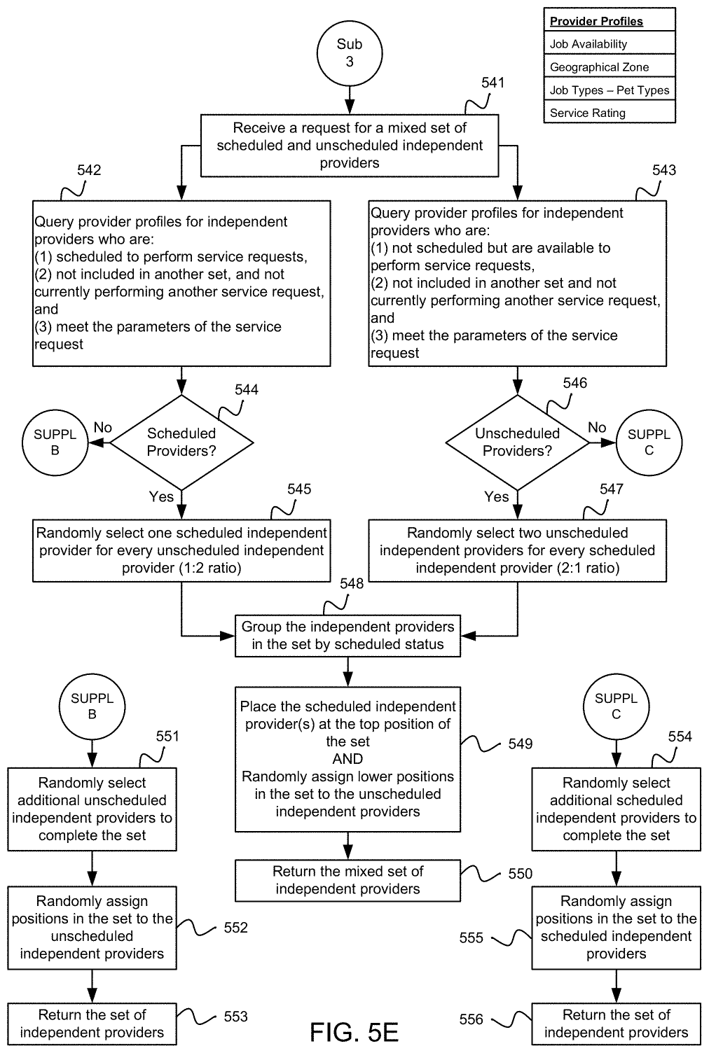

As described above, the service-provider system 100 may apply bias in selecting an initial set of preferred independent-providers. However, the order in which the profiles of the preferred independent-providers is displayed in the customer user-interface 102 may not be biased. For example, the order of the profiles in the customer user-interface 102 may be random (e.g., using a random number generator). A bias may not be applied when selecting subsequent sets of independent-provider profiles. For example, subsequent sets of independent-provider profiles can include those scheduled previously (i.e., scheduled their availability to fulfill service requests) and those who did not schedule for a date and time of the requested service but went “live” by submitting their willingness to fulfill service requests. A detailed example of a method used by the provider-dynamics model 108 to select a set of independent-provider profiles so as to provide each independent-provider profile included in the provider pool 110 a possibility to be included in the set of independent-provider profiles is described later in association with FIGS. 5A-E.

The service-provider system 100 allows for customer review and choice of an independent-provider during a review period, which may be a defined amount of time (e.g., 60 seconds, 120 seconds, 2 minutes, etc.). In one example, during the customer review period, a customer may review profiles for a preferred set of independent-providers, and may request additional profiles for subsequent sets of independent-providers. After the customer review period has expired, the time in which the customer can choose an independent-provider concludes. To start again, the customer can “refresh” or resubmit the service request and begin the process again.

As part of managing the flow of independent-provider profiles moving in-and-out of the provider pool 110, the provider-dynamics model 108 temporarily removes the preferred independent-providers and any subsequently displayed independent-providers from the provider pool 110 during a customer review period. During this time, the independent-providers are not available to accept other service requests. In one example, a hold and release of an independent-provider profile may be displayed in a provider user-interface using, for example, an icon that visually indicates the independent-provider's status as it pertains to their visibility in searches and their availability to fulfill service requests.

The time which an independent-provider may held out of the provider pool 110 may be dependent on when the independent-provider was selected for the service request. For example, an independent-provider included in an initial preferred set of independent-provider profiles may be held for the entire duration of the customer review period, whereas a non-preferred independent-provider who's profile was later added to the search results displayed in the customer user-interface 102 (e.g., the 40-second mark) would be held for the remainder of the customer review period. The provider-dynamics model 108 can release a hold on an independent-provider profiles and return the profile to the provider pool 110 when the customer confirms their choice of an independent-provider through the customer user-interface 102, or after the customer review period has expired. Removing independent-provider profiles from the provider pool 110 in response to receiving service requests, and returning the independent-provider profiles to the provider pool 110 when the independent-provider profiles are not selected for the service requests, allows the provider-dynamics model 108 to regulate the supply and demand between service requests and independent-providers available to perform the service requests. That is, the provider-dynamics model 108 holds independent-providers for a minimum about of time to allow a customer to choose a provider, and then return unselected independent-providers to the provider pool 110 to help ensure that an adequate number of independent-provider profiles are in the provider pool 110 for other service requests.

FIG. 2 illustrates an example service-provider system 200 for managing a flow of independent-provider profiles moving in-and-out of a provider pool in response to service requests. The service-provider system 200 may include one or more server computers 202 which may be in communication with a number of client devices 204/206a-c via a network. In one example, the server computer 202 may be located in a data center, service provider environment (“cloud” environment), or a hybrid environment (public and private cloud combination). A server computer 202 may be configured to execute processing modules for providing customers access to independent-providers who are available to perform on-demand services. For example, the processing modules may receive a service request sent from a customer device 204 and query a data store containing a provider pool 208 of independent-provider profiles in order to identify a set of independent-provider profiles that correspond to the parameters of the service request. The processing modules may send the independent-provider profiles to the customer device 204 to allow the independent-provider profiles to be displayed in a customer user-interface 210.

In the example illustrated, the server computer 202 hosts a processing module configured to execute a provider-dynamics model 214 that manages a flow of independent-provider profiles moving in-and-out of the provider pool 208 by removing independent-provider profiles from the provider pool 208 in response to receiving service requests, and returning the independent-provider profiles to the provider pool 208 when the independent-provider profiles are not selected for the service requests. As described later in association with FIGS. 5A-E, the provider-dynamic model 214 selects a set of independent-provider profiles using factors to provide each independent-provider profile, included in the provider pool 208 that corresponds to the parameters of the service request, a possibility to be included in the set of independent-provider profiles. As part of identifying a set of independent-provider profiles that correspond to the parameters of a service request, the provider-dynamics model 214 may set a candidate flag for each independent-provider in the set of independent-providers. For example, the provider-dynamics model 214 may set a candidate flag (e.g., a value that acts as a signal) in an independent-provider profile stored in the data store. Setting the candidate flag places a temporary hold on the independent-providers, preventing the independent-providers from being selected for other service requests. As part of setting the candidate flag, the provider-dynamics model 214 may start a timer for the temporary hold, or monitor a customer review time displayed in the customer user-interface 210.

In one example, when setting a candidate flag for an independent-provider, the processing modules may send a message to an independent-provider device 206a-c that indicates that the temporary hold has been placed on the independent-provider. In response to receiving the message, the independent-provider device 206a-c may display an indication in a provider user-interface 212 that the temporary hold has been placed on the independent-provider. Accordingly, the independent-provider may be provided with a visual indicator that the independent-provider is a candidate for a service request. The provider-dynamics model 214 may clear the candidate flag (e.g., change or delete the value in an independent-provider profile) in response to a selection of an independent-provider included in the set of independent-providers, or in response to an expiration of the temporary hold.

The processing modules may receive from a customer client device 204 a selection of an independent-provider to perform a service request. In response to receiving the selection, the provider-dynamics model 214 may clear the candidate flags from the independent-provider profile in the data store. The processing modules may send a message to an independent-provider device 206a-c indicating that the independent-provider has been selected to perform the service request. In response to receiving the message, the independent-provider device 206a-c may display an indication in the provider user-interface 212 that the independent-provider has been selected to perform the service request. The processing modules may also send a message to the other independent-provider devices 206a-c that instructs the independent-provider devices 206a-c to remove the indication of the temporary hold from the provider user-interface 212.

A client device 204/206a-c may include any device capable of sending and receiving data over a network 220. A customer client device 204 may host a customer application configured to communicate with the processing modules on the server computer 202, and to provide the customer user-interface 210. An independent-provider client device 206a-c may host an independent-provider application configured to communicate with the processing modules on the server computer 202, and to provide the provider user-interface 212. A client device 204/206a-c may comprise, for example a processor-based system such as a computing device. A client device 204/206a-c may be a device such as, but not limited to, a mobile device, a desktop computer, laptop or notebook computer, tablet computer, handheld computer, or other devices with like capability.

The various processes and/or other functionality contained within the service-provider system 200 may be executed on one or more processors that are in communication with one or more memory modules. The service-provider system 200 may include a number of computing devices that are arranged, for example, in one or more server banks or computer banks or other arrangements. The computing devices may support a computing environment using hypervisors, virtual machine monitors (VMMs) and other virtualization software. The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

API calls, procedure calls or other network commands that may be made in relation to the processing modules included in the service-provider system 200 may be implemented according to different technologies, including, but not limited to, Representational state transfer (REST) technology or Simple Object Access Protocol (SOAP) technology. REST is an architectural style for distributed hypermedia systems. A RESTful API (which may also be referred to as a RESTful web service) is a web service API implemented using HTTP and REST technology. SOAP is a protocol for exchanging information in the context of Web-based services.

The network 220 may include any useful computing network, including an intranet, the Internet, a local area network, a wide area network, a wireless data network, or any other such network or combination thereof. Components utilized for such a system may depend at least in part upon the type of network and/or environment selected. Communication over the network 220 may be enabled by wired or wireless connections and combinations thereof.

FIG. 2 illustrates that certain processing modules may be discussed in connection with this technology and these processing modules may be implemented as computing services. In one example configuration, a processing module may be considered a service with one or more processes executing on a server or other computer hardware. Such services may be centrally hosted functionality or a service application that may receive requests and provide output to other services or consumer devices. For example, processing modules providing services may be considered on-demand computing that are hosted in a server, virtualized service environment, grid, or cluster computing system. An API may be provided for each processing module to enable a second processing module to send requests to and receive output from the first processing module. Such APIs may also allow third parties to interface with the processing module and make requests and receive output from the processing modules. While FIG. 2 illustrates an example of a system environment that may implement the techniques above, many other similar or different system environments are possible. The example system environments discussed and illustrated above are merely representative and not limiting.

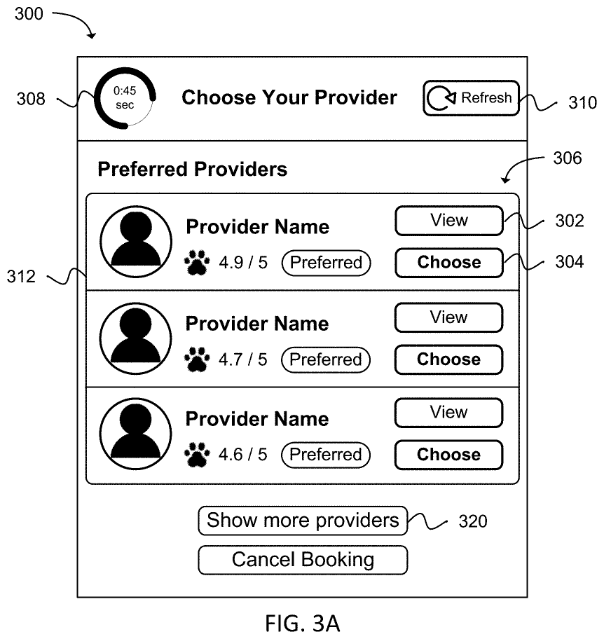

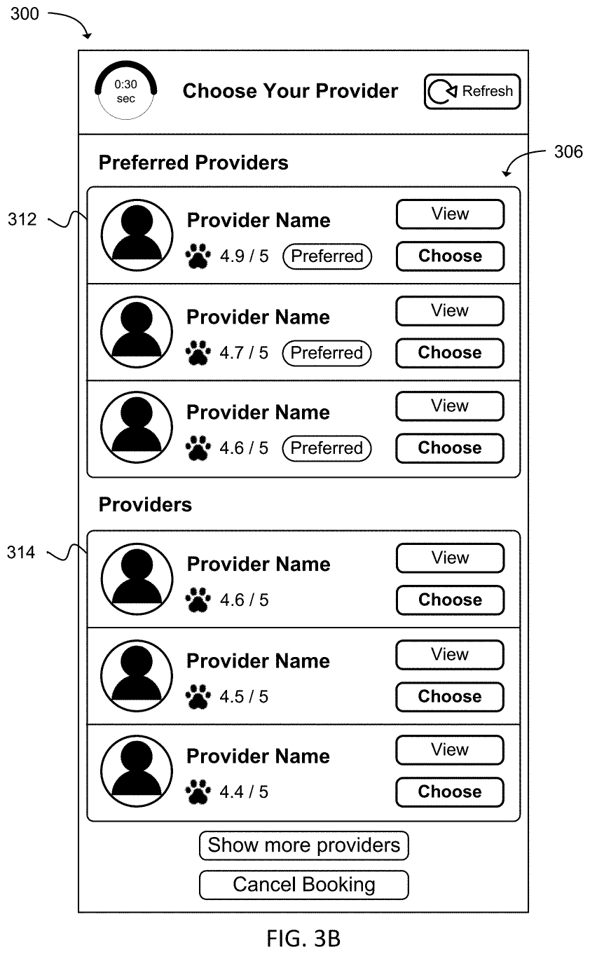

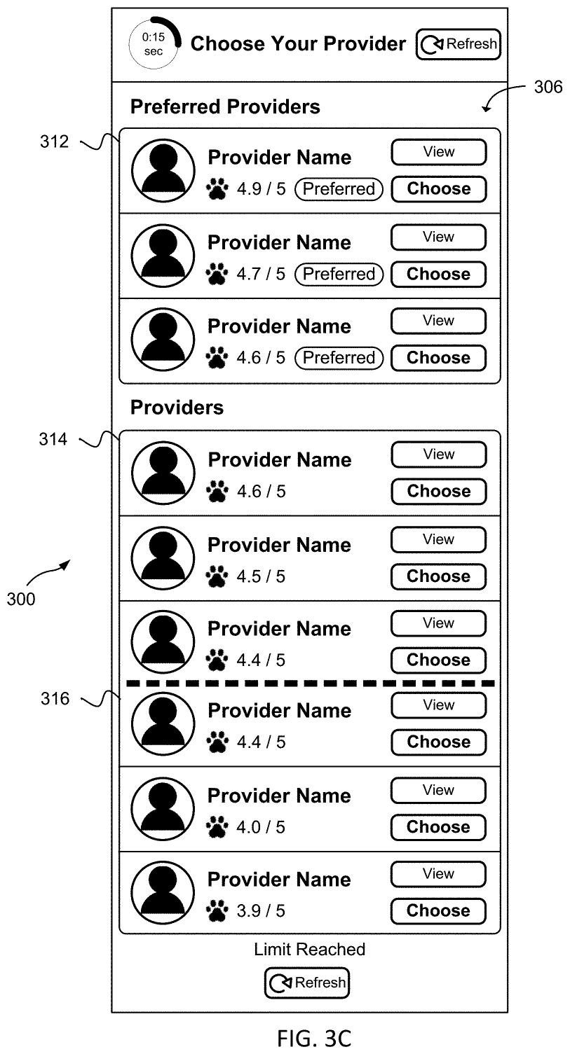

FIGS. 3A-C illustrate an example of a customer user-interface 300 that allows a customer to book on-demand services from independent-providers with the ability to review independent-provider profiles in real-time. The customer user-interface 300 can display independent-provider search results returned in response to a service request. The customer user-interface 300 can include interactive controls 302/304 to allow a customer to view independent-provider profiles and to choose an independent-provider to perform the service request. The customer user-interface 300 may also include a timer control 308 to provide a visual indicator of a review period and a refresh control 310 to allow a customer to refresh or resubmit a service request.

The customer user-interface 300 can include a provider display region 306 containing a plurality of locations for dynamically displaying independent-provider profiles. A subset of locations or each location in the provider display region 306 may correspond to one or more factors used by a provider-dynamic model to select sets of independent-provider profiles from a provider pool. As one example, a top location 312 in the provider display region 306 may be for displaying profiles selected using factors for identifying preferred independent-providers. A middle location 314 in the provider display region 306 may be for displaying profiles selected using factors for identifying non-preferred independent-providers. A bottom location 316 in the provider display region 306 may be for displaying profiles selected using factors for identifying a mixed set of scheduled and on-demand independent providers. As will be appreciated, the provider display region 306 can include any number of locations for displaying independent-provider profiles. The number of locations included in the provider display region 306 are not limited to the locations shown and described in association with FIGS. 3A-C.

As shown in FIG. 3A, an initial set of search results displayed in the customer user-interface 300 can include profiles for preferred independent-providers who, for example, have highest cumulative metrics as determined by individual ratings from previous services. The customer user-interface 300 can include an interactive control 320 (e.g., a “show more” button) that allows a customer to request a second set of independent-provider search results. In response to selecting the interactive control, the customer user-interface 300 may send a search request for independent-provider profiles to a server that hosts a provider-dynamics model, as described earlier. As shown in FIG. 3B, the customer user-interface 300 may receive search results for the second set of independent-providers from the server and display the search results in the customer user-interface 300. The second set of independent-providers may contain profiles for non-preferred independent providers, and the profiles may be displayed below the preferred independent providers. The customer may review the second set of search results during the review period, and the customer may again select the interactive control to request a third set of search results which, as shown in FIG. 3C, can be displayed in the customer user-interface 300 below the second set of search results. The customer may request additional search results up until the review period expires or the pool of independent-providers is exhausted.

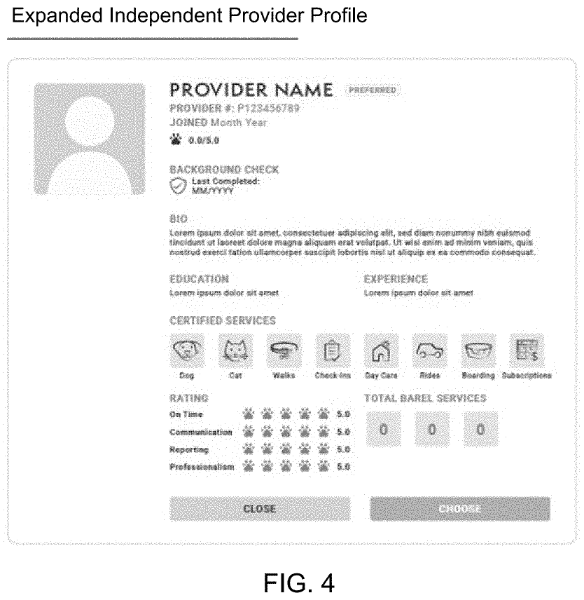

As described above, the customer user-interface 300 can include an interactive control 302 (e.g., a view expanded profile button) that allows a customer to view an expanded profile for an independent-provider obtained from the server. Selecting the interactive control 302 may cause the customer user-interface 300 to display the profile. For example, as shown in FIG. 4, an expanded independent-provider profile may include information such as, but not limited to, an independent-provider's name, background, bio, education, experience, certifications, ratings, completed services, etc.

FIGS. 5A-E are flow diagrams that illustrate an example method 500 for dynamically displaying independent-provider profiles in a user-interface to allow a customer to book an independent-provider to perform an on-demand service. Referring to FIG. 5A, as shown in block 501, parameters defining a service request may be received at a server included in a service provider-system that includes a main process and a number of sub-process used to implement the provider-dynamics model described earlier. As in block 502, in response to receiving the service request, the main process may request that a sub-process “Sub 1” provide a set of preferred independent-provider profiles to display in the user-interface.

In reference to FIG. 5B, in response to the request for the set of preferred independent-provider profiles, as in block 514, the sub-process “Sub 1” may, as in block 515, query a provider pool of independent-provider profiles using factors to identify preferred independent-providers. In one example, the factors may include: independent-providers who are scheduled to perform service requests during the service request time, independent-providers who satisfy the parameters of the service request (e.g., located in a specified geographical zone, performs the job type requested, works with the pet type specified in the request, has high service rating, etc.), independent-providers who are not currently performing another service request, as well as other factors. As in block 516, the provider-dynamics model may then select two or more of the preferred independent-providers based on service rating. For example, the preferred independent-providers who have highest cumulative metrics determined by individual user ratings may be selected to be included in the set of preferred independent-providers. In one example, as part of identifying the preferred set of independent-providers, the sub-process “Sub 1” may set a candidate flag for each independent-provider in the set of independent-providers. Setting the candidate flag may place a temporary hold on the independent-providers that prevents the independent-providers from being selected for other service requests. As in block 517, the preferred independent-providers can be ordered by their service rating, and as in block 519, the set of preferred independent-providers can be returned to the main process.

As in block 518, in the case that there are not enough preferred independent-providers for a full set, then the set of preferred independent-providers can be supplemented with on-demand or “live” independent-providers. As described earlier, on-demand or “live” independent-providers may be providers who did not schedule for a date and time of the requested service, but went “live” by submitting their willingness to fulfill service requests. Accordingly, the sub-process “Sub 1” can request that another sub-process “SUPPL A” identify on-demand or “live” independent-providers who are unscheduled, but are available to perform the service request, to include in the set of preferred independent-providers. For example, as shown in FIG. 5D, in response to receiving the request, the sub-process “SUPPL A”, as in block 529, can query independent-provider profiles to identify on-demand providers who satisfy the parameters of the service request. In the case that on-demand providers are identified, then as shown in blocks 534-540, a set of independent-providers containing on-demand providers can be returned to the main process. However, as shown in blocks 530, 531, and 533, if there are no on-demand providers available who can perform the service request, a partial set of preferred independent providers is returned to the main process. In the case that not even a partial set of independent-providers is available, then as in block 532, an indication that no independent-providers are available can be returned to the main process.

Returning to FIG. 5A, the set of preferred independent-providers returned to the main process may be displayed in the user-interface on a customer's client device, as in block 503. The customer is provided an opportunity (e.g., a review time) to review the independent-provider profiles in the set. If the customer selects one of the independent-providers displayed in the user-interface, then as in block 512, the independent-provider can be notified, and as in block 513, the remainder of the independent-providers in the set can be released to the provider pool so that the independent-providers are available to fulfill other service requests. In one example, releasing the independent-providers to the provider pool may comprise clearing a candidate flag set on the independent-providers.

As in block 504, should the customer choose not to select an independent-provider from the preferred set of independent-provider profiles, then as in block 505, the customer can request a second set of independent-provider profiles containing profiles for non-preferred independent-providers to display in the user-interface. A request for a set of non-preferred independent-provider profiles can be sent to a sub-process “Sub 2”. In reference to FIG. 5C, as in block 520, the sub-process “Sub2” can receive a request for a set of non-preferred independent-providers and, as in block 521, query the provider pool of independent-provider profiles using factors to identify independent-providers who satisfy an initial set of factors. The initial set of factors used to query the provider pool may include: independent-providers who are scheduled to perform service requests during the service request time, independent-providers who are not currently performing another service request, independent-providers who satisfy the parameters of the service request (e.g., located in a specified geographical zone, performs the job type requested, works with the pet type specified in the request, has high service rating, etc.), as well as other factors. In one example, as part of identifying the non-preferred set of independent-providers, the sub-process “Sub 2” may set a candidate flag for each independent-provider in the set of independent-providers. Setting the candidate flag may place a temporary hold on the independent-providers that prevents the independent-providers from being selected for other service requests.

After identifying independent-provider profiles that meet the initial factors, as in block 522, the sub-process “Sub2” can group the independent-provider profiles by customer rating to form N groups of independent-providers. As a non-limiting example, the independent-provider profiles can be divided into three service rating groups, where each group contains independent-provider profiles having a customer rating that falls within a customer rating range for the group (e.g., group A, rating 4.5-5; group B, rating 3.5-4.5; and group C, rating 2.5-3.5).

After creating the N groups, as in block 523, the sub-process “Sub2” can, for each group, determine overall ratings for the independent-providers in the group based on the customer rating and an internal rating. As an example, the customer rating and the internal rating can be combined to form an overall rating for an independent-provider. The internal rating can be based on a number of internal company metrics for an independent-provider, such as: a percentage of jobs accepted, on-time performance, amount of time-on-platform, number of completed services, and other metrics.

As in block 524, the sub-process “Sub2” may select a profile for the highest overall rated independent-provider from each of the N groups, and include the profiles in the set of non-preferred independent-providers. The sub-process “Sub2” can then return the set of non-preferred independent providers to the main process, as in block 527. As in block 525, in the case that there are not enough non-preferred independent-providers for a full set, then sub-process “SUPPL A” (shown in FIG. 5D) can be called to supplement the set of non-preferred independent-providers with on-demand or “live” independent-providers.

Returning again to FIG. 5A, the set of non-preferred independent-providers returned to the main process may be displayed in the user-interface on a customer's client device, as in block 506. The customer can review the non-preferred independent-provider profiles during the review time. If the customer selects one of the independent-providers displayed in the user-interface, then as in block 512, the independent-provider can be notified, and as in block 513, the remainder of the independent-providers in the set can be released to the provider pool so that the independent-providers are available to fulfill other service requests. In one example, releasing the independent-providers to the provider pool may comprise clearing a candidate flag set on the independent-providers. However, as in block 507, should the customer choose not to select an independent-provider from the preferred set or the non-preferred set of independent-provider profiles shown in the user-interface, then as in block 508, the customer can request a third set of independent-provider profiles containing a mixed set of profiles for scheduled and unscheduled “live” independent-providers to display in the user-interface 509.

In response to the customer request for the third set of independent-provider profiles, the main process can send a request to a sub-process “Sub 3” at 508. In reference to FIG. 5E, as in block 541, the sub-process “Sub3” can receive the request for a mixed set of scheduled and unscheduled independent-providers and, as in blocks 542 and 543, query the provider pool of independent-provider profiles using factors to identify scheduled and unscheduled independent-providers. As in blocks 544 and 546, in the case that there are not enough scheduled and/or unscheduled independent-providers, then as shown in blocks 551-556, additional independent-providers can be randomly selected to complete the set.

As in block 545 and 547, the sub-process “Sub3” can randomly select scheduled and unscheduled independent-providers from each group using a selection ratio. For example, two unscheduled independent-providers can be randomly selected for each scheduled independent-provider that is randomly selected. Of course it will be appreciated that any selection ratio can be used. By randomly selecting profiles, the independent-providers are afforded a more “equal” opportunity to be shown in the user-interface, which provides them with an opportunity to be selected for a service request and a chance to raise their ratings and move up a display order of preferred and/or non-preferred independent-providers. In one example, as part of identifying the mixed set of independent-providers, the sub-process “Sub 3” may set a candidate flag for each independent-provider in the set of independent-providers. Setting the candidate flag may place a temporary hold on the independent-providers that prevents the independent-providers from being selected for other service requests.

Having randomly selected the scheduled and unscheduled independent-providers, the sub-process “Sub 3”, as in block 548, can group the independent-providers in the set using the scheduled status of the independent-providers (i.e., scheduled and unscheduled). Accordingly, the set can contain a scheduled group and an unscheduled group of independent-provider profiles. As in block 549, the sub-process “Sub 3” can order the set by placing the profiles for the group of scheduled independent-providers at the top of the set, and randomly assigning lower positions in the set to profiles for the group of unscheduled independent-providers. As in block 550, the sub-process “Sub 3” can then return the mixed set of profiles for scheduled and unscheduled independent-providers to the main process.

Returning once again to FIG. 5A, the main process can receive profiles for the mixed set of independent-providers and, as in block 509, display the profiles in the user-interface on a customer's client device. The customer can review the profiles for the mixed set of independent-provider during the review time. If the customer selects one of the independent-providers displayed in the user-interface 510, then as in block 512, the independent-provider can be notified, and as in block 513, the remainder of the independent-providers in the set can be released to the provider pool so that the independent-providers are available to fulfill other service requests. In one example, releasing the independent-providers to the provider pool may comprise clearing a candidate flag set on the independent-providers. As in block 511, if the customer does not select an independent-provider displayed in the user-interface during the review time, and the review time expires, then as in block 513, the independent-providers displayed in the user-interface can be returned to the provider pool. At this point, the customer can restart the selection process via the user-interface (e.g., a refresh button), whereupon the main process can obtain a new set of profiles for independent providers to display in the user-interface.

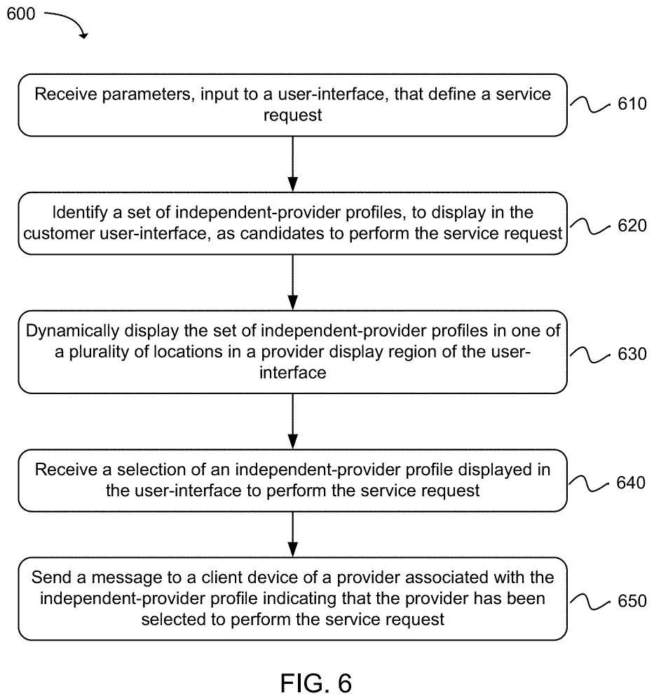

FIG. 6 is a flow diagram that illustrates an example method 600 for a user interface to display independent-provider profiles. Starting in block 610, parameters defining a service request can be received, wherein a customer inputs the parameters into a user-interface. In response to receiving the parameters, a provider-dynamics model can be used to identify a set of independent-provider profiles to display in the customer user-interface, as in block 620. The independent-providers associated with the profiles can be presented to the customer as candidates to perform the service request. In one example, the provider-dynamics model can select the set of independent-provider profiles using factors to provide each independent-provider profile, included in a provider pool that corresponds to the parameters of the service request, a possibility to be included in the set of independent-provider profiles. The provider-dynamics model can manage a flow of independent-provider profiles moving in-and-out of the provider pool by: removing independent-provider profiles from the provider pool in response to receiving service requests, and returning the independent-provider profiles to the provider pool when the independent-provider profiles are not selected for the service requests who have attributes that correspond to the parameters defining the service request.

As in block 630, the set of independent-provider profiles can be dynamically displayed in one of a plurality of locations in a provider display region of the user-interface. Each location in the provider display region may correspond to one or more factors used by the provider-dynamics model to select sets of independent-provider profiles from the provider pool. Also, at least a part of a set of independent-provider profiles dynamically displayed in one of the locations of the provider display region can be replaced with different independent-provider profiles selected by the provider-dynamics model from the provider pool in response to an expiration time or a refresh action.

The customer can view the profiles for the independent-providers shown in the user-interface and select an independent-provider to perform the service request. In response, as in block 640, the selection of the independent-provider profile can be received, and as in block 650, a message can be sent to a client device of a provider associated with the independent-provider profile indicating that the provider has been selected to perform the service request.

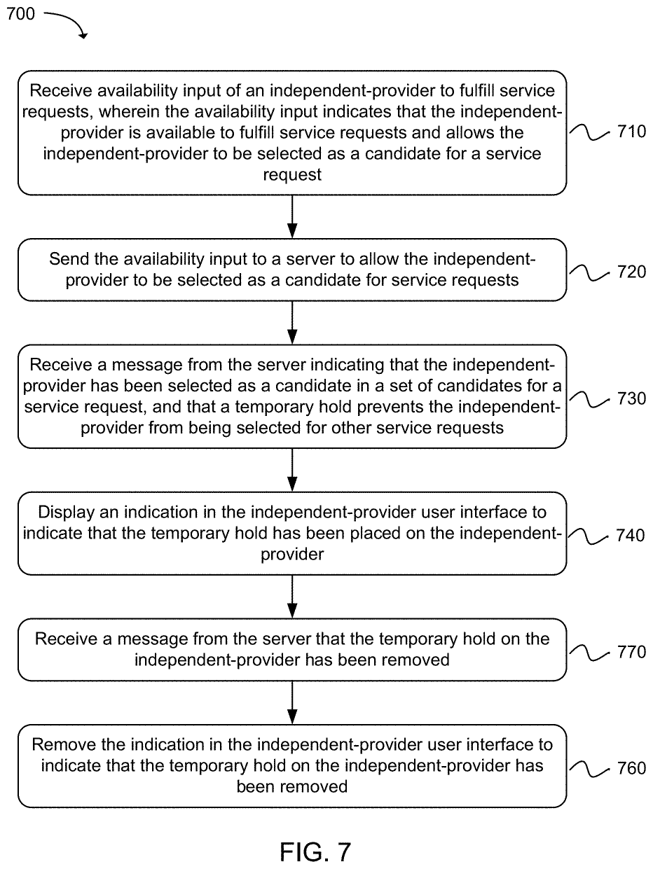

FIG. 7 is a flow diagram illustrating an example method 700 for holding an independent-provider during a customer review period. As in block 710, a provider user-interface may receive availability input for an independent-provider. The availability input may indicate that the independent-provider is available to fulfill service requests and allows the independent-provider to be selected as a candidate for a service request. In one example, the availability input of the independent-provider may include either of: a schedule of availability, or an indication that the independent-provider is currently available to fulfill service requests. As in block 720, an independent-provider application hosted on an independent-provider's client device may send the availability input to a server to allow the independent-provider to be selected as a candidate for service requests.

Sometime thereafter, as in block 730, the independent-provider application may receive a message from the server indicating that the independent-provider has been selected as a candidate in a set of candidates for a service request, and that a temporary hold has been placed on the independent-provider that prevents the independent-provider from being selected for other service requests. In response to receiving the message, as in block 740, the provider user-interface may display an indication in the provider user-interface that indicates that the temporary hold has been placed on the independent-provider.

In the case that the independent-provider is selected by a customer to perform the service request, the independent-provider application may receive a message from the server indicating that the independent-provider has been selected to perform the service request, and an indication may be displayed in the provider user-interface to indicate the selection of the independent-provider to perform the service request. In the case that the independent-provider is not selected to perform the service request, the temporary hold will expire and the independent-provider will again be available for other service requests.

As in block 750, the provider user-interface may receive a message from the server that the temporary hold on the independent-provider has been removed, and in response to receiving the message, as in block 760, the provider user-interface may remove the indication in the provider user-interface to indicate that the temporary hold on the independent-provider has been removed.

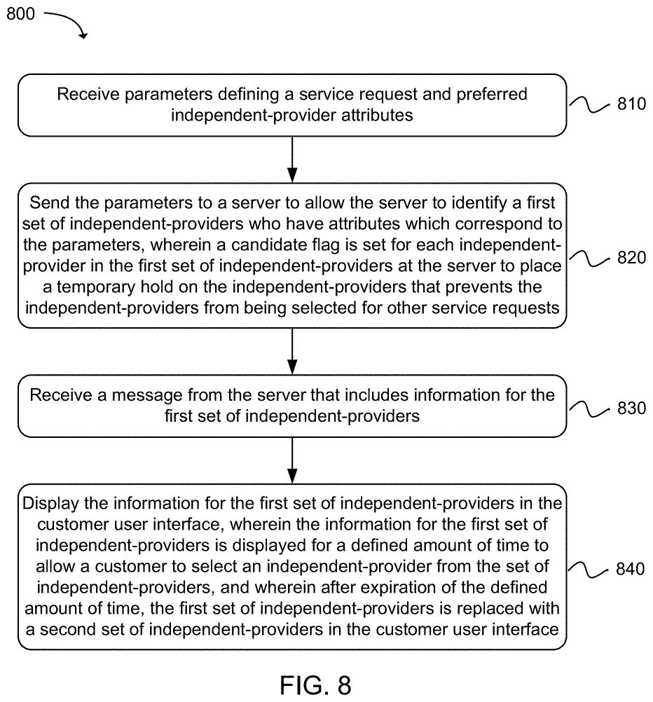

FIG. 8 is a flow diagram that illustrates an example method 800 for requesting a service using a customer user-interface. As in block 810, the customer user-interface may receive parameters defining a service request and preferred independent-provider attributes. In response to receiving the service request parameters, as in block 820, a customer application hosted on a client device may send the parameters to a server to allow the server to identify a first set of independent-providers who have attributes which correspond to the parameters. The server may set a candidate flag for each independent-provider in the first set of independent-providers to place a temporary hold on the independent-providers that prevents the independent-providers from being selected for other service requests.

As in block 830, the customer application may receive a message from the server that includes information for the first set of independent-providers. In response, as in block 840, the customer application may display the information for the first set of independent-providers in the customer user-interface. The information for the first set of independent-providers may be displayed for a defined amount of time to allow a customer to select an independent-provider from the set of independent-providers. After the defined amount of time expires, the temporary hold on the first set of independent-providers may be removed.

In one example, prior to the expiration of the temporary hold, the customer user-interface may receive a customer request for a second set of independent-providers. In response, the customer application may send the customer request to the server. The server may identify a set of non-preferred independent providers who are able to perform the service request, and the server may send a message that includes information for the second set of independent-providers to the customer application. In response to receiving the message from the server, the customer application may display the information for the second set of independent-providers in the customer user-interface. In one example, the information for the second set of independent-providers may be displayed below the first set of independent providers in the customer user-interface.

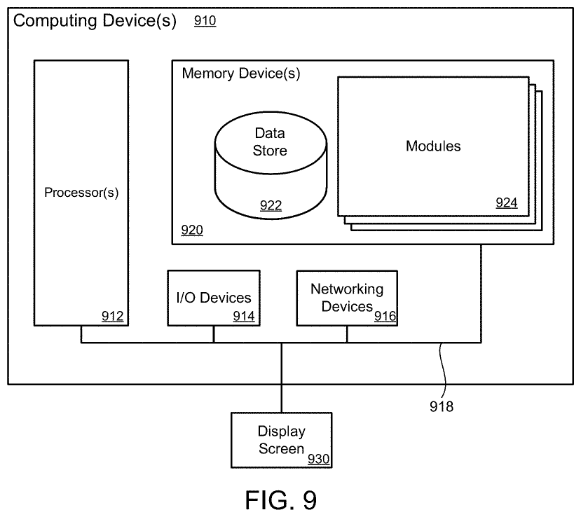

FIG. 9 illustrates a computing device 910 on which modules of this technology may execute. A computing device 910 is illustrated on which a high level example of the technology may be executed. The computing device 910 may include one or more processors 912 that are in communication with memory devices 920. The computing device 910 may include a local communication interface 918 for the components in the computing device 910. For example, the local communication interface 918 may be a local data bus and/or any related address or control busses as may be desired.

The memory device 920 may contain modules 924 that are executable by the processor(s) 912 and data for the modules 924. In one example, the modules 924 may include a module configured for a provider-dynamics model, a customer user-interface module, a provider user-interface module, and other modules. The modules 924 may execute the functions described earlier. A data store 922 may also be located in the memory device 920 for storing data related to the modules 924 and other applications along with an operating system that is executable by the processor(s) 912.

Other applications may also be stored in the memory device 920 and may be executable by the processor(s) 912. Components or modules discussed in this description may be implemented in the form of software using high-level programming languages that are compiled, interpreted or executed using a hybrid of the methods.

The computing device 910 may also have access to I/O (input/output) devices 914 that are usable by the computing device 910. One example of an I/O device may include a display screen 930. Networking devices 916 and similar communication devices may be included in the computing device 910. The networking devices 916 may be wired or wireless networking devices that connect to the internet, a LAN, WAN, or other computing network.

The components or modules that are shown as being stored in the memory device 920 may be executed by the processor(s) 912. The term “executable” may mean a program file that is in a form that may be executed by a processor 912. For example, a program in a higher level language may be compiled into machine code in a format that may be loaded into a random access portion of the memory device 920 and executed by the processor 912, or source code may be loaded by another executable program and interpreted to generate instructions in a random access portion of the memory to be executed by a processor. The executable program may be stored in any portion or component of the memory device 920. For example, the memory device 920 may be random access memory (RAM), read only memory (ROM), flash memory, a solid state drive, memory card, a hard drive, optical disk, floppy disk, magnetic tape, or any other memory components.

The processor 912 may represent multiple processors and the memory device 920 may represent multiple memory units that operate in parallel to the processing circuits. This may provide parallel processing channels for the processes and data in the system. The local communication interface 918 may be used as a network to facilitate communication between any of the multiple processors and multiple memories. The local communication interface 918 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function.

Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The present technologies disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. The present technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A computer implemented method for a user-interface to display independent-provider profiles, comprising:
receiving parameters, input to the user-interface, that define a service request;
identifying a set of independent-provider profiles to display in the user-interface as candidates to perform the service request,
wherein a provider-dynamics model selects the set of independent-provider profiles using factors to provide each independent-provider profile, included in a provider pool that corresponds to the parameters of the service request, a possibility to be included in the set of independent-provider profiles,
wherein the provider-dynamics model manages a flow of independent-provider profiles moving in-and-out of the provider pool by removing independent-provider profiles from the provider pool in response to receiving service requests, and returning the independent-provider profiles to the provider pool when the independent-provider profiles are not selected for the service requests; and
dynamically displaying the set of independent-provider profiles in one of a plurality of locations in a provider display region of the user-interface,
wherein each location in the provider display region corresponds to one or more factors used by the provider-dynamics model to select sets of independent-provider profiles from the provider pool, and
wherein at least a part of a set of independent-provider profiles dynamically displayed in one of the locations of the provider display region is replaced with different independent-provider profiles selected by the provider-dynamics model from the provider pool in response to an expiration time or a refresh action.

2. The computer implemented method in claim 1, wherein identifying the set of independent-provider profiles to display in the user-interface further comprises:
identifying a first set of independent-provider profiles using factors to identify preferred independent providers, wherein the factors include:
selecting independent-provider profiles for providers who are scheduled to perform service requests during a time indicated in the service request and have highest cumulative metrics determined by service ratings,
wherein the first set of independent-provider profiles are displayed in a top location in the provider display region of the user-interface.

3. The computer implemented method in claim 1, wherein identifying the set of independent-provider profiles to display in the user-interface further comprises:
identifying a second set of independent-provider profiles using factors to identify non-preferred independent providers, wherein the factors include:
selecting independent-provider profiles for providers who are scheduled to perform service requests during a time indicated in the service request,
grouping the independent-provider profiles by customer ratings to form N groups of independent-provider profiles,
assigning overall ratings to the independent provider profiles in the N groups based on the customer ratings and internal ratings of the providers, and
selecting highest overall rated independent provider profiles from each of the N groups,
wherein the second set of independent-provider profiles are displayed in a location in the provider display region of the user-interface that is below a location for preferred independent-provider profiles.

4. The computer implemented method in claim 1, wherein identifying the set of independent-provider profiles to display in the user-interface further comprises:
identifying a third set of independent-provider profiles using factors to identify a mixed set of scheduled and on-demand independent providers, wherein the factors include:
randomly selecting scheduled independent providers and on-demand independent providers from the provider pool, where one scheduled independent provider is selected for every two on-demand independent providers selected,
wherein the third set of independent-provider profiles are displayed a location in the provider display region of the user-interface that is below a location for non-preferred independent-provider profiles.

5. The computer implemented method in claim 4, wherein displaying the third set of independent-provider profiles in the user-interface further comprises:
ordering the third set of independent-provider profiles to place the scheduled independent providers above the on-demand independent providers, and
randomly assigning the on-demand independent providers to lower positions in the third set of independent-provider profiles.

6. The computer implemented method in claim 1, further comprising:
receiving a selection of an independent-provider profile displayed in the user-interface to perform the service request; and
sending a message to a client device of a provider associated with the independent-provider profile indicating that the provider has been selected to perform the service request.

7. The computer implemented method in claim 1, wherein managing the flow of independent-provider profiles in-and-out of the provider pool further comprises:
setting a candidate flag for each independent-provider profile included in a set of independent-providers to temporarily remove the independent-provider profiles from the provider pool, making independent-providers associated with the independent-provider profiles unavailable to perform other service requests.

8. The computer implemented method in claim 7, further comprising sending a message to a plurality of client devices of independent-providers associated with the independent-provider profiles to indicate in a provider user-interface that a temporary hold has been placed on the independent-providers.

9. The computer implemented method in claim 7, further comprising:
clearing the candidate flag from an independent-provider profile in response to one of: a selection of the independent-provider profile for the service request, the expiration time, or the refresh action,
wherein clearing the candidate flag returns the independent-provider profile to the provider pool.

10. The computer implemented method in claim 8, further comprising:
sending a message to a plurality of client devices of the independent-providers associated with the independent-provider profiles to indicate in the provider user-interface that the temporary hold on the independent-providers has been removed.

11. A system for a user-interface to display independent-provider profiles, comprising:
at least one processor;
a memory device including instructions that, when executed by the at least one processor, cause the system to:
receive parameters, input to the user-interface, that define a service request;
identify a set of independent-provider profiles to display in the user-interface as candidates to perform the service request,
wherein a provider-dynamics model selects the set of independent-provider profiles using factors to provide each independent-provider profile, included in a provider pool that corresponds to the parameters of the service request, a possibility to be included in the set of independent-provider profiles,
wherein the provider-dynamics model manages a flow of independent-provider profiles moving in-and-out of the provider pool by removing independent-provider profiles from the provider pool in response to receiving service requests, and returning the independent-provider profiles to the provider pool when the independent-provider profiles are not selected for the service requests; and
dynamically display the set of independent-provider profiles in one of a plurality of locations in a provider display region of the user-interface,
wherein each location in the provider display region corresponds to one or more factors used by the provider-dynamics model to select sets of independent-provider profiles from the provider pool, and
wherein at least a part of a set of independent-provider profiles dynamically displayed in one of the locations of the provider display region is replaced with different independent-provider profiles selected by the provider-dynamics model from the provider pool in response to an expiration time or a refresh action.

12. The system in claim 11, wherein the instructions that identify the set of independent-provider profiles to display in the user-interface further comprise instructions that, when executed by the at least one processor, cause the system to:
select independent-provider profiles for providers who are scheduled to perform service requests during a time indicated in the service request and have highest cumulative metrics determined by service ratings,
wherein the set of independent-provider profiles are displayed in a top location in the provider display region of the user-interface.

13. The system in claim 11, wherein the instructions that identify the set of independent-provider profiles to display in the user-interface further comprise instructions that, when executed by the at least one processor, cause the system to:
identify a second set of independent-provider profiles using factors to identify non-preferred independent providers, wherein the factors include:
select independent-provider profiles for providers who are scheduled to perform service requests during a time indicated in the service request,
group the independent-provider profiles by customer ratings to form N groups of independent-provider profiles,
assign overall ratings to the independent provider profiles in the N groups based on the customer ratings and internal ratings of the providers, and
select highest overall rated independent provider profiles from each of the N groups,
wherein the second set of independent-provider profiles are displayed in a location in the provider display region of the user-interface that is below a location for preferred independent-provider profiles.

14. The system in claim 11, wherein the instructions that identify the set of independent-provider profiles to display in the user-interface further comprise instructions that, when executed by the at least one processor, cause the system to:
identify a third set of independent-provider profiles using factors to identify a mixed set of scheduled and on-demand independent providers, wherein the factors include:
randomly select scheduled independent providers and on-demand independent providers from the provider pool, where one scheduled independent provider is selected for every two on-demand independent providers selected,
order the third set of independent-provider profiles to place the scheduled independent providers above the on-demand independent providers, and
randomly assign the on-demand independent providers to lower positions in the third set of independent-provider profiles,
wherein the third set of independent-provider profiles are displayed a location in the provider display region of the user-interface that is below a location for non-preferred independent-provider profiles.

15. The system in claim 11, wherein the memory device further includes instructions that, when executed by the at least one processor, cause the system to:
receive a selection of an independent-provider profile displayed in the user-interface to perform the service request; and
send a message to a client device of an independent-provider associated with the independent-provider profile indicating that the independent-provider has been selected to perform the service request.

16. A non-transitory machine-readable storage medium including instructions embodied thereon for a user-interface, wherein the instructions, when executed by at least one processor:
receive parameters, input to the user-interface, that define a service request;
identify a set of independent-provider profiles to display in the user-interface as candidates to perform the service request,
wherein a provider-dynamics model selects the set of independent-provider profiles using factors to provide each independent-provider profile, included in a provider pool that corresponds to the parameters of the service request, a possibility to be included in the set of independent-provider profiles,
wherein the provider-dynamics model manages a flow of independent-provider profiles moving in-and-out of the provider pool by removing independent-provider profiles from the provider pool in response to receiving service requests, and returning the independent-provider profiles to the provider pool when the independent-provider profiles are not selected for the service requests; and
dynamically display the set of independent-provider profiles in one of a plurality of locations in a provider display region of the user-interface,
wherein each location in the provider display region corresponds to one or more factors used by the provider-dynamics model to select sets of independent-provider profiles from the provider pool,
wherein at least a part of a set of independent-provider profiles dynamically displayed in one of the locations of the provider display region is replaced with different independent-provider profiles selected by the provider-dynamics model from the provider pool in response to an expiration time or a refresh action.

17. The non-transitory machine-readable storage medium in claim 16, wherein the instructions that identify the set of independent-provider profiles to display in the user-interface further comprise instructions, that when executed by the at least one processor:
select independent-provider profiles for providers who are scheduled to perform service requests during a time indicated in the service request and have highest cumulative metrics determined by service ratings,
wherein the set of independent-provider profiles are displayed in a top location in the provider display region of the user-interface.

18. The non-transitory machine-readable storage medium in claim 16, wherein the instructions that identify the set of independent-provider profiles to display in the user-interface further comprise instructions, that when executed by the at least one processor:
identify a second set of independent-provider profiles using factors to identify non-preferred independent providers, wherein the factors include:
select independent-provider profiles for providers who are scheduled to perform service requests during a time indicated in the service request,
group the independent-provider profiles by customer ratings to form N groups of independent-provider profiles,
assign overall ratings to the independent provider profiles in the N groups based on the customer ratings and internal ratings of the providers, and
select highest overall rated independent provider profiles from each of the N groups,
wherein the second set of independent-provider profiles are displayed in a location in the provider display region of the user-interface that is below a location for preferred independent-provider profiles.

19. The non-transitory machine-readable storage medium in claim 16, wherein the instructions that identify the set of independent-provider profiles to display in the user-interface further comprise instructions, that when executed by the at least one processor:
identify a third set of independent-provider profiles using factors to identify a mixed set of scheduled and on-demand independent providers, wherein the factors include:
randomly select scheduled independent providers and on-demand independent providers from the provider pool, where one scheduled independent provider is selected for every two on-demand independent providers selected,
order the third set of independent-provider profiles to place the scheduled independent providers above the on-demand independent providers, and
randomly assign the on-demand independent providers to lower positions in the third set of independent-provider profiles,
wherein the third set of independent-provider profiles are displayed a location in the provider display region of the user-interface that is below a location for non-preferred independent-provider profiles.

20. The non-transitory machine-readable storage medium in claim 16, further comprising instructions, that when executed by the at least one processor:
receive a selection of an independent-provider profile displayed in the user-interface to perform the service request; and
send a message to a client device of a provider associated with the independent-provider profile indicating that the provider has been selected to perform the service request.
